(19) United States
(12) Patent Application Publication
(10) Pub. No.: US 2025/0364755 A1
(43) Pub. Date: Nov. 27, 2025

(54) CONNECTOR

(71) Applicant: JAPAN AVIATION ELECTRONICS INDUSTRY, LIMITED, Tokyo (JP)

(72) Inventor: Kazuki KUGO, Tokyo (JP)

(73) Assignee: JAPAN AVIATION ELECTRONICS INDUSTRY, LIMITED, Tokyo (JP)

(21) Appl. No.: 19/089,344

(22) Filed: Mar. 25, 2025

(30) Foreign Application Priority Data
May 23, 2024 (JP) 2024-083761

(51) Int. Cl. H01R 13/652; H01R 13/05; H01R 13/187

(52) U.S. Cl. CPC H01R 13/652; H01R 13/052; H01R 13/187

(57) ABSTRACT

A connector comprises a contact formed with a receiving portion and an electric-shock protection pin having a support portion and an end portion. The end portion is resiliently deformable and is located in the receiving portion. The end portion is located at a front end of the electric-shock protection pin in a front-rear direction and is supported by the support portion. Under an initial state where the support portion is not resiliently deformed, the end portion is located at a predetermined position and is apart from the contact in a perpendicular plane perpendicular to the front-rear direction. The end portion is moved from the predetermined position in the perpendicular plane in accordance with resilient deformation of the support portion. The end portion moved from the predetermined position returns to the predetermined position in accordance with a return of the support portion to the initial state.

### CROSS REFERENCE TO RELATED APPLICATIONS

This application is based on and claims priority under 35 U.S.C. § 119 to Japanese Patent Application No. JP 2024-083761 filed May 23, 2024, the content of which is incorporated herein in its entirety by reference.

### BACKGROUND OF THE INVENTION

This invention relates to a connector comprising an electric-shock protection pin.

For example, this type of connector is disclosed in JPH08-78079A (Patent Document 1), the content of which is incorporated herein by reference.

Referring to FIG. 16, Patent Document 1 discloses a receptacle (connector) 90 mateable with a plug (mating connector) 97, which is located forward of the connector 90, along a front-rear direction (X-direction). Thus, the mating direction of the illustrated connector 90 is the front-rear direction.

The connector 90 comprises a socket contact (contact) 92 for a large current and an insulation pole (electric-shock protection pin) 96. The contact 92 is covered by an insulation member in a plane perpendicular to the front-rear direction. The contact 92 is formed with a receiving portion 94 located therein. The receiving portion 94 is a space which opens forward. The mating connector 97 comprises a pin contact (mating contact) 98. The mating contact is formed with a hole portion 99.

The electric-shock protection pin 96 is located in the receiving portion 94 and extends to a front end of the receiving portion 94 along the front-rear direction. The thus-arranged electric-shock protection pin 96 makes it difficult for an operator to insert his/her finger into the receiving portion 94. This structure prevents an electric-shock which might be caused when an operator's finger is brought into contact with the contact 92.

When the connector 90 and the mating connector 97 are mated with each other, the electric-shock protection pin 96 is received in the hole portion 99 of the mating contact 98 so that the electric-shock protection pin 96 is restricted in its movement. The connector 90 is moved so as to be inclined with the front-rear direction when receiving a force along a direction intersecting with the mating direction (front-rear direction) under a state where the electric-shock protection pin 96 has been received in the hole portion 99. If the connector 90 is excessively inclined, the electric-shock protection pin 96 received in the hole portion might be plastically deformed into a bent shape.

### SUMMARY OF THE INVENTION

It is therefore an object of the present invention to provide a connector comprising an electric-shock protection pin which is hardly deformed plastically even when the connector receives a force along a direction intersecting with a mating direction.

An aspect of the present invention provides a connector mateable with a mating connector, which is located forward of the connector, along a front-rear direction, the mating connector comprising a mating contact. The connector comprises a housing, a contact and an electric-shock protection pin. The housing is formed with an accommodation portion. The accommodation portion opens forward. The contact is accommodated in the accommodation portion and is held by the housing. The contact is formed with a receiving portion. The receiving portion is configured to receive the mating contact along the front-rear direction when the connector is mated with the mating connector. The electric-shock protection pin has a support portion and an end portion. The support portion is resiliently deformable and is located in the receiving portion. The end portion is located at a front end of the electric-shock protection pin and is supported by the support portion. The end portion has an insulation surface. Under an initial state where the support portion is not resiliently deformed, the end portion is located at a predetermined position and is apart from the contact in a perpendicular plane perpendicular to the front-rear direction. The end portion is moved from the predetermined position in the perpendicular plane in accordance with resilient deformation of the support portion. The end portion moved from the predetermined position returns to the predetermined position in accordance with a return of the support portion to the initial state.

According to the electric-shock protection pin of an aspect of the present invention, when the end portion is moved in a direction perpendicular to the front-rear direction (mating direction), the support portion is not plastically deformed but makes the end portion return to the predetermined position by using the restoring force caused by its resilient deformation. According to this mechanism, the electric-shock protection pin is not plastically deformed but is resiliently deformed, for example, even when the connector is inclined by a force applied thereto along a direction intersecting with the front-rear direction (mating direction) under a state where the connector and the mating connector are mated with each other. Thus, the present invention provides a connector comprising an electric-shock protection pin which is hardly deformed plastically even when the connector receives a force along a direction intersecting with a mating direction.

An appreciation of the objectives of the present invention and a more complete understanding of its configuration may be had by studying the following description of the preferred embodiment and by referring to the accompanying drawings.

### BRIEF DESCRIPTION OF THE DRAWINGS

FIG. 1 is a perspective view showing a connector and a mating connector according to an embodiment of the present invention, wherein the connector and the mating connector are under a separated state where they are separated from each other.

FIG. 2 is a side view showing the connector and the mating connector of FIG. 1, wherein the connector and the mating connector are under a mated state where they are mated with each other, and an outline of a housing under a state where the connector is inclined is illustrated with dashed line.

FIG. 3 is a front view showing a mating portion of the connector of FIG. 1.

FIG. 4 is a front view showing the connector and the mating connector of FIG. 1.

FIG. 5 is a cross-sectional view showing the connector and the mating connector of FIG. 4, taken along line V-V.

FIG. 6 is a cross-sectional view showing a contact, an electric-shock protection pin and a part of the housing of the connector of FIG. 5, wherein an outline of the resiliently deformed electric-shock protection pin is illustrated with dashed line.

FIG. 7 is a cross-sectional view showing the contact and the electric-shock protection pin of FIG. 6 under the mated state, wherein outlines of the contact and the electric-shock protection pin under a state where the connector is inclined are illustrated with dashed line.

FIG. 8 is a perspective view showing the contact and the electric-shock protection pin of FIG. 6.

FIG. 9 is an exploded, perspective view showing the contact and the electric-shock protection pin of FIG. 8.

FIG. 10 is a front view showing the contact and the electric-shock protection pin of FIG. 9.

FIG. 11 is a cross-sectional view showing the contact and the electric-shock protection pin of FIG. 10, taken along line XI-XI, wherein a part of the electric-shock protection pin enclosed by dashed line is enlarged and illustrated.

FIG. 12 is a perspective view showing a modification of the contact and the electric-shock protection pin of FIG. 8.

FIG. 13 is an exploded, perspective view showing the contact and the electric-shock protection pin of FIG. 12, wherein an additional member of the contact is enlarged and illustrated.

FIG. 14 is a front view showing the contact and the electric-shock protection pin of FIG. 12.

FIG. 15 is a cross-sectional view showing the contact and the electric-shock protection pin of FIG. 14, taken along line XV-XV.

FIG. 16 is a cross-sectional view showing a connector and a mating connector of Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

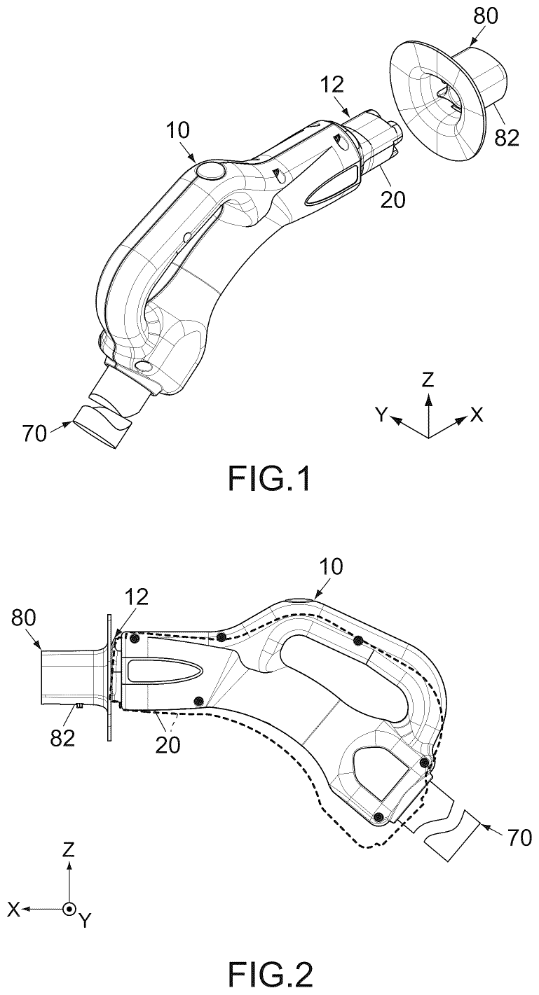

Referring to FIGS. 1 and 2, a connector 10 according to an embodiment of the present invention is mateable with a mating connector 80, which is located forward of the connector 10, along a front-rear direction. Thus, the mating direction of the present embodiment is the front-rear direction. The connector 10 and the mating connector 80 shown in FIG. 1 are under a separated state where they are separated from each other. The connector 10 and the mating connector 80 shown in FIG. 2 are under a mated state where they are mated with each other. The front-rear direction of the present embodiment is the X-direction. In the present embodiment, “forward” means the positive X-direction, and “rearward” means the negative X-direction. The words such as the front-rear direction do not indicate the absolute positional relation relative to the ground but merely indicate a relative positional relation under a definition that the mating connector 80 under the mated state is located forward of the connector 10.

The connector 10 of the present embodiment is a charging connector. The connector 10 is connected to a charging device (not shown) via a cable 70. The mating connector 80 is incorporated in an electric vehicle (not shown) such as an electric car. The connector 10 supplies a large current to the mating connector 80 through the cable 70 under the mated state. However, the present invention is not limited thereto but is variously applicable.

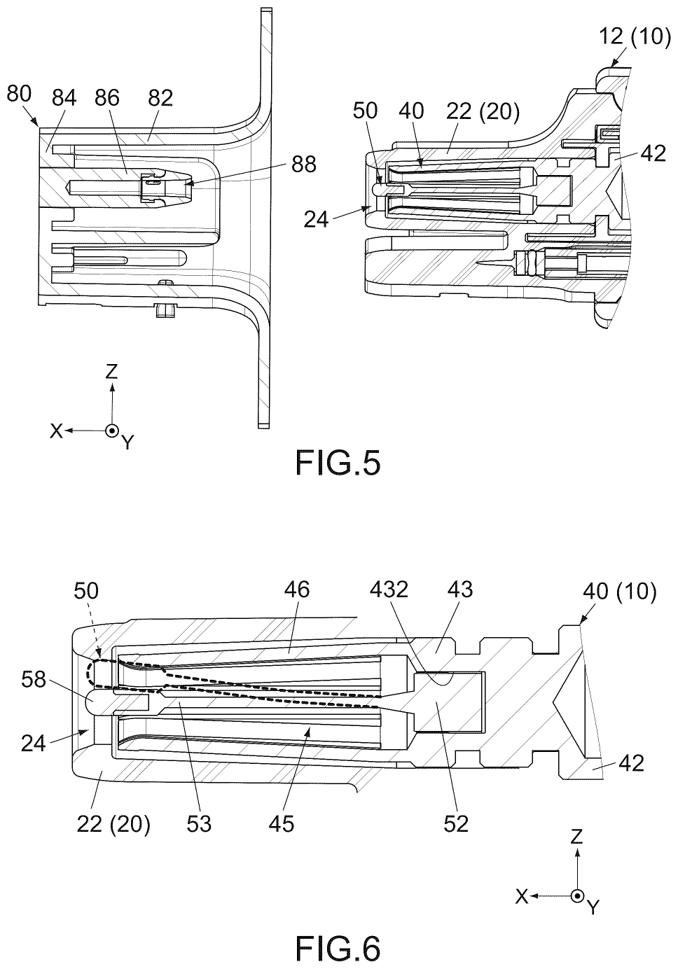

Referring to FIGS. 4 and 5, the mating connector 80 comprises a mating housing 82 made of insulator and two mating contacts 86 each made of conductor. Each of the mating contacts 86 is a pin. Each of the mating contacts 86 is held by a rear plate 84 of the mating housing 82 and extends rearward from the rear plate 84 along the front-rear direction. The two mating contacts 86 are arranged in a lateral direction perpendicular to the front-rear direction. The lateral direction of the present embodiment is the Y-direction.

The mating connector 80 of the present embodiment comprises the aforementioned members. However, the present invention is not limited thereto. For example, the mating housing 82 may be provided as necessary. The number of the mating contacts 86 may be one, three or more. The mating connector 80 may further comprise another member in addition to the aforementioned members.

As shown in FIG. 5, each of the mating contacts 86 of the present embodiment is formed of two members which are combined together in the front-rear direction. Each of the mating contacts 86 is formed with a hole portion 88. Each of the hole portions 88 is located at the middle of the mating contact 86 in a perpendicular plane (YZ-plane) perpendicular to the front-rear direction. Each of the hole portions 88 extends along the front-rear direction. Each of the hole portions 88 opens rearward while becoming wider in the perpendicular plane. Each of the mating contacts 86 of the present embodiment has the aforementioned structure. However, the present invention is not limited thereto. For example, each of the mating contacts 86 may be a single member.

Referring to FIGS. 1 and 2, the connector 10 has a mating portion 12 configured to be mated with the mating connector 80. The mating portion 12 is located at a front end of the connector 10 in the front-rear direction and is located at an upper part of the connector 10 in an up-down direction perpendicular to both the front-rear direction and the lateral direction. The up-down direction of the present embodiment is the Z-direction. In the present embodiment, “upward” means the positive Z-direction, and “downward” means the negative Z-direction.

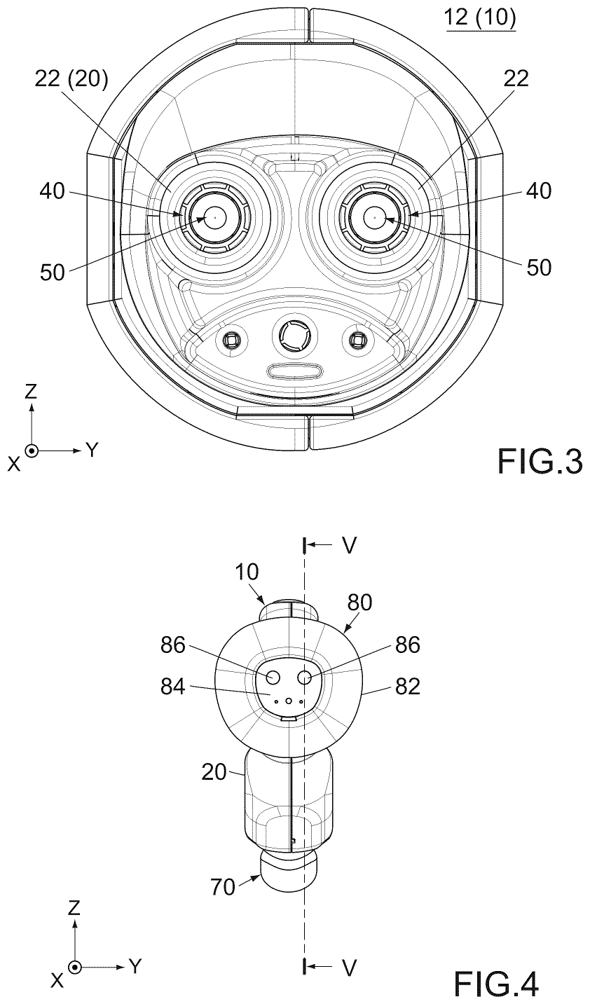

Referring to FIG. 3, the connector 10 of the present embodiment comprises a housing 20 made of insulator, two contacts 40 and two electric-shock protection pins 50. The contacts 40 and the electric-shock protection pins 50 are provided in the mating portion 12. Each of the contacts 40 is a socket. Referring to FIG. 3 together with FIG. 4, the contacts 40 are provided so as to correspond to the mating contacts 86, respectively. The electric-shock protection pins 50 are provided so as to correspond to the contacts 40, respectively.

The connector 10 of the present embodiment comprises the aforementioned members and the aforementioned portion. However, the present invention is not limited thereto. For example, the number of the contacts 40 may be one, three or more. The number of the electric-shock protection pins 50 may be one, three or more. The connector 10 may further comprise another member and another portion in addition to the aforementioned members and the aforementioned portion.

Referring to FIGS. 3 and 5, the mating portion 12 of the present embodiment is provided with two wall portions 22 which correspond to the contacts 40, respectively. Each of the wall portions 22 is a part of the housing 20. Thus, the housing 20 has the wall portions 22. Each of the wall portions 22 has a cylindrical shape and projects forward. Each of the wall portions 22 is formed with an accommodate portion 24 which is a cylindrical space located inside the wall portion 22. Thus, the housing 20 is formed with two of the accommodate portions 24. Each of the accommodate portions 24 opens forward. Each of the wall portions 22 is located around the accommodate portion 24 in the perpendicular plane (YZ-plane). Each of the wall portions 22 of the present embodiment encloses the accommodate portion 24 with no gap in the perpendicular plane.

The mating portion 12 of the housing 20 of the present embodiment has the aforementioned structure. However, the present invention is not limited thereto. The structure of the mating portion 12 can be modified as necessary.

Hereafter, explanation will be made about one of the contacts 40. The explanation described below is applicable to each of the contacts 40.

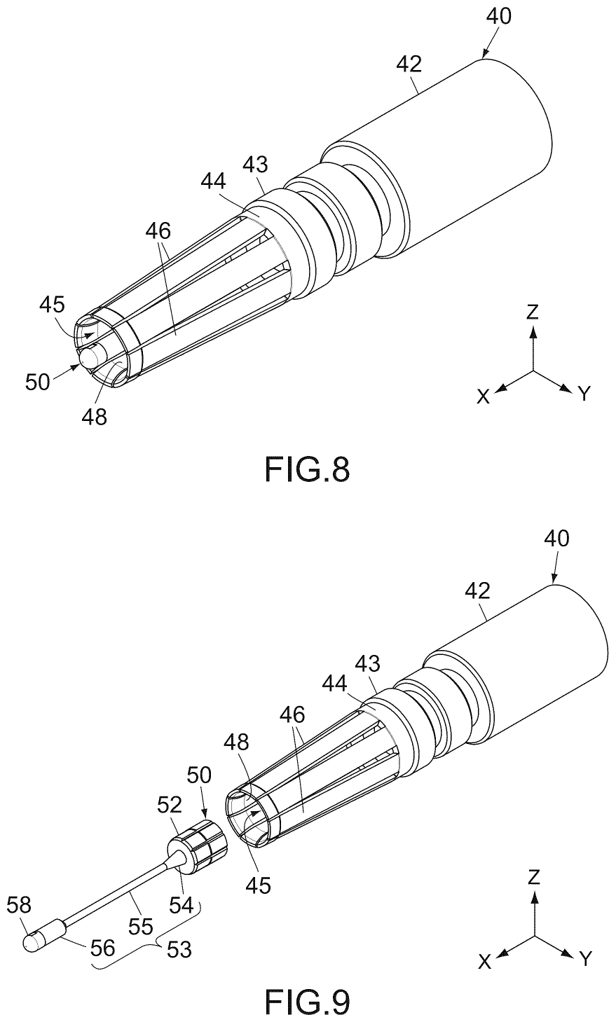

Referring to FIG. 8, the contact 40 of the present embodiment is a single member made of metal. The contact 40 of the present embodiment has a cable connection portion 42, a holding portion 43, a coupling portion 44 and a plurality of spring pieces 46. Each of the cable connection portion 42 and the holding portion 43 has a cylindrical outline. The coupling portion 44 has a cylindrical shape.

Referring to FIG. 11, the cable connection portion 42 is located at a rear part of the contact 40 and is configured to be connected to a wire (not shown) of the cable 70 (see FIG. 1). The holding portion 43 is located forward of the cable connection portion 42. The holding portion 43 is formed with a cylindrical holding hole 432 located therein. The coupling portion 44 is located forward of the holding portion 43. Each of the spring pieces 46 is connected to a front edge of the coupling portion 44 and extends forward from the coupling portion 44. Thus, the coupling portion 44 couples the spring pieces 46 together. Each of the spring pieces 46 is a cantilever which extends from the coupling portion 44. According to this structure, each of the spring pieces 46 is resiliently deformable in the perpendicular plane (YZ-plane) and has a front end which is a free end.

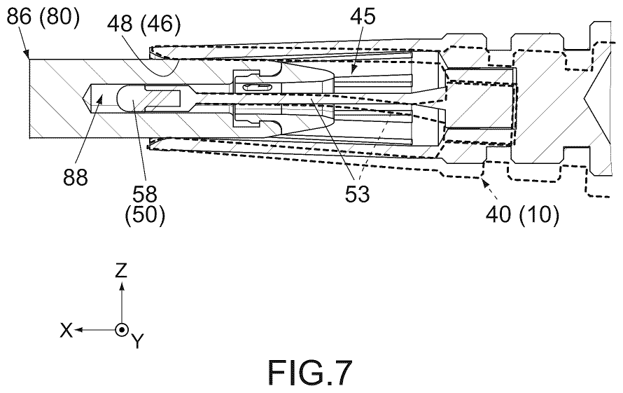

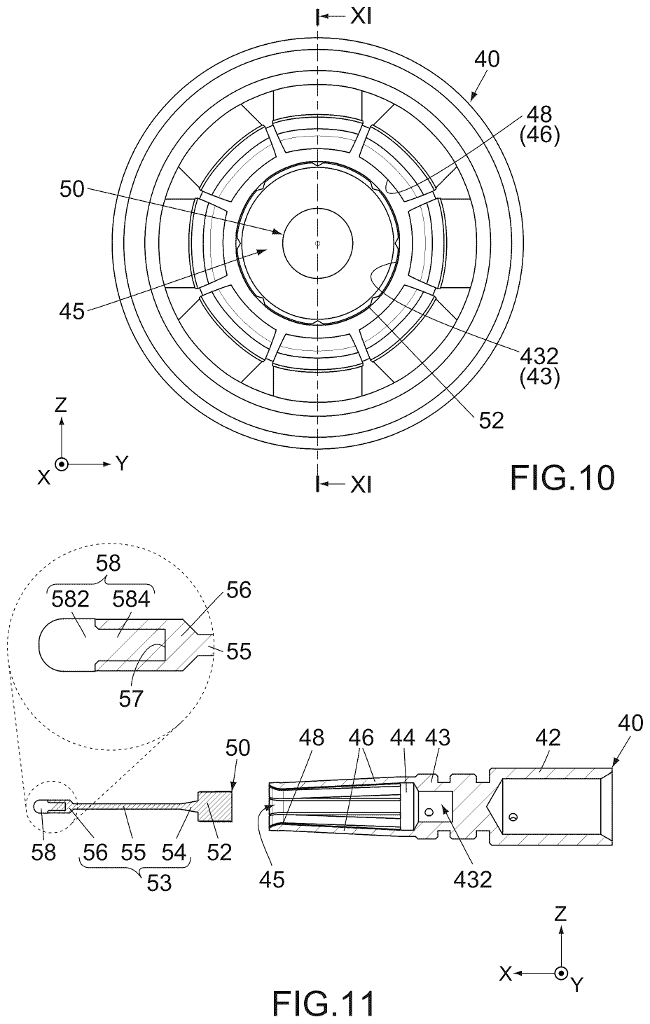

Referring to FIGS. 8 and 10, the spring pieces 46 of the present embodiment are arranged in a circle in the perpendicular plane (YZ-plane) at regular intervals. As a result, the contact 40 is formed with a receiving portion 45. The receiving portion 45 of the present embodiment is a space which is enclosed by the coupling portion 44 and eight of the spring pieces 46 in the perpendicular plane. The receiving portion 45 extends along the front-rear direction and opens forward. The receiving portion 45 has volume which can receive one finger. Referring to FIG. 7, the receiving portion 45 is configured to receive the mating contact 86 along the front-rear direction when the connector 10 is mated with the mating connector 80.

Referring to FIGS. 8 and 10, each of the spring pieces 46 has a contact portion 48. Thus, the contact 40 of the present embodiment has a plurality of the contact portions 48. The contact portions 48 are located at positions same as each other in the front-rear direction. The contact portions 48 are arranged in a circle in the perpendicular plane (YZ-plane) at regular intervals and protrude inward in the perpendicular plane.

Referring to FIG. 7, each of the spring pieces 46 is resiliently deformed in the perpendicular plane (YZ-plane) under the mated state. The thus-deformed spring pieces 46 press the mating contact 86 which is surrounded by the spring pieces 46, and thereby the contact portions 48 are brought into contact with the mating contact 86 with a sufficient contact force. As a result, the charging device (not shown) connected to the connector 10 is electrically connected with the mating connector 80, and a large current flows through the contact 40.

The contact 40 of the present embodiment is a so-called slotted terminal which has the structure described above. However, the present invention is not limited thereto. The structure of the contact 40 can be modified as necessary, provided that the contact 40 is formed with the receiving portion 45.

Referring to FIGS. 5 and 6, the contact 40 is accommodated in the accommodate portion 24 and is held by the housing 20. The contact 40 is fixed to the housing 20 so as not to be unmovable relative to the housing 20. In other words, the contact 40 is moved in accordance with a movement of the housing 20.

According to the present embodiment, the contact 40 is wholly located in the housing 20. In detail, the most part of the contact 40 excluding the cable connection portion 42 is completely accommodated in the accommodate portion 24 and is completely covered by the wall portion 22 in the perpendicular plane (YZ-plane). The housing 20 is formed with a gap which is located between the contact 40 and the wall portion 22 in the perpendicular plane. However, a front end of the wall portion 22 protrudes inward in the perpendicular plane and covers the gap from the front. Accordingly, no finger can touch the outer surface of the contact 40.

The contact 40 of the present embodiment is arranged in the housing 20 as described above. However, the present invention is not limited thereto. For example, the contact 40 and the wall portion 22 may be in close contact with each other in the perpendicular plane (YZ-plane) with no gap formed therebetween.

Hereafter, explanation will be made about one of the electric-shock protection pins 50. The explanation described below is applicable to each of the electric-shock protection pins 50.

Referring to FIGS. 9 and 11, the electric-shock protection pin 50 of the present embodiment has a held portion 52 made of metal, a support portion 53 made of metal and an end portion 58 made of insulator. The held portion 52 and the support portion 53 of the present embodiment are formed integrally with each other. The held portion 52 is located at a rear end of the electric-shock protection pin 50 and has a cylindrical shape. The support portion 53 is connected to a front end of the held portion 52 and extends forward from the held portion 52. The end portion 58 is located at a front end of the electric-shock protection pin 50 and is supported by the support portion 53.

Referring to FIGS. 6 and 10, the held portion 52 of the present embodiment is press-fit into the holding hole 432 of the contact 40 which is fixed to the housing 20. As a result, the held portion 52 is fixed to the housing 20 so as to be unmovable relative to the housing 20. In other words, the held portion 52 is moved in accordance with a movement of the housing 20. The held portion 52 of the present embodiment is directly fixed to the contact 40. However, the present invention is not limited thereto. For example, the held portion 52 may be indirectly fixed to the contact 40. More specifically, the held portion 52 may be fixed to a holder (not shown) other than the contact 40. In this instance, the holder may be fixed to the contact 40.

Referring to FIG. 6, the support portion 53 is resiliently deformable. In detail, the support portion 53 is under an initial state and is not substantially deformed resiliently when the electric-shock protection pin 50 receives no force except for the gravity (see the electric-shock protection pin 50 illustrated with solid line in FIG. 6). The support portion 53 is resiliently deformed as illustrated by dashed line when the electric-shock protection pin 50 receives a force.

As shown in FIGS. 9 and 11, the support portion 53 of the present embodiment has a rod-like shape which extends along the front-rear direction. In detail, the support portion 53 has a round rod shape which extends along the front-rear direction. The thus-formed support portion 53 is resiliently deformable equally in any direction on the perpendicular plane (YZ-plane). However, the present invention is not limited thereto. For example, the support portion 53 may have a rectangular rod shape which extends along the front-rear direction or may have a flat-plate shape which extends along the front-rear direction.

The support portion 53 of the present embodiment has a base portion 54, a rear portion 55 and a front portion 56. The base portion 54 has a truncated cone shape and projects forward from a front end surface of the held portion 52. The rear portion 55 has a round rod shape and extends forward from a front end of the base portion 54. The front portion 56 is connected to a front end of the rear portion 55 and is located forward of the rear portion 55. Thus, the rear portion 55 extends rearward from the front portion 56. The front portion 56 supports the end portion 58. The rear portion 55 has a size in the perpendicular plane (YZ-plane) which is smaller than a size of the front portion 56 in the perpendicular plane except for a boundary between the front portion 56 and the rear portion 55. Thus, the rear portion 55 is slimmer than the front portion 56 and is resiliently deformable more easily than the front portion 56.

The support portion 53 of the present embodiment has the aforementioned structure. When a force is applied to the end portion 58, the rear portion 55 is resiliently deformed more easily than any other part of the support portion 53. The end portion 58 is moved in accordance with resilient deformation of the rear portion 55. However, the present invention is not limited thereto. The structure of the support portion 53 can be modified as necessary. For example, the base portion 54 may be a coil spring. The coil spring may have a rear end which is not indirectly fixed to the contact 40 via the held portion 52 but is directly fixed to the contact 40.

The electric-shock protection pin 50 of the present embodiment is made of copper or copper alloy. Thus, the support portion 53 of the electric-shock protection pin 50 is made of metal and is easily deformed resiliently. The contact 40 of the present embodiment is also made of copper or copper alloy. Thus, the held portion 52 of the electric-shock protection pin 50 is made of a type of metal same as that of the holding portion 43 of the contact 40. This structure reduces corrosion which might occurs at a boundary between the electric-shock protection pin 50 and the contact 40. Moreover, the electric-shock protection pin 50 can be made of a type of copper alloy which is softer than that of the contact 40 while the contact 40 can be made of pure copper whose conductivity is higher than that of the electric-shock protection pin 50. However, the present invention is not limited thereto. For example, the support portion 53 of the electric-shock protection pin 50 may be made of a type of metal different from that of the contact 40 or may be made of insulator.

Referring to FIG. 11, the end portion 58 of the present embodiment is made of insulator and has a main portion 582 and a fixed portion 584. The main portion 582 has a cylindrical shape except for its front end. The front end of the main portion 582 has a hemispherical shape projecting forward. The fixed portion 584 projects rearward from the main portion 582. The front portion 56 of the support portion 53 is formed with a fixation hole 57. The end portion 58 is insert-molded so that the fixed portion 584 is embedded in the fixation hole 57. The thus-formed end portion 58 has an insulation surface.

The end portion 58 of the present embodiment has the aforementioned structure. However, the present invention is not limited thereto. For example, the fixed portion 584 may be screwed into the fixation hole 57 to be fixed to an inner surface of the fixation hole 57. The front portion 56 of the support portion 53 may have a pin-like part which projects forward. In this instance, the end portion 58 made of insulator may be attached to the pin-like part so as to cover the pin-like part. Instead, the end portion 58 may be made of metal. In this instance, the surface of the end portion 58 may be coated with an insulation film.

Referring to FIG. 6 together with FIG. 10, the support portion 53 is located in the receiving portion 45 of the corresponding contact 40. The support portion 53 of the present embodiment is located at the center of the receiving portion 45 in the perpendicular plane (YZ-plane) under the initial state. The support portion 53 of the present embodiment is completely located in the receiving portion 45 except for a front end of the front portion 56. The end portion 58 is located beyond a front end of the contact 40 in the front-rear direction. In other words, the end portion 58 is located outside the receiving portion 45. However, the present invention is not limited thereto. For example, the support portion 53 including the front end of the front portion 56 may be completely located in the receiving portion 45.

The end portion 58 which is arranged as described above prevents insertion of a finger into the receiving portion 45. Thus, no finger can touch any metal part which is located in or in the vicinity of the receiving portion 45. The present embodiment prevents an electric-shock which might be caused when a finger is brought into contact with the contact 40.

Referring to FIG. 7, the support portion 53 and the end portion 58 are received in the hole portion 88 of the mating contact 86 under the mated state. The mating contact 86 can be inserted into the receiving portion 45 while the support portion 53 and the end portion 58 are received in the hole portion 88. The support portion 53 and the end portion 58 of the present embodiment can be easily inserted into the hole portion 88 because they extend like a round rod as a whole. The end portion 58 which has a hemispherical front end can be smoothly inserted into the hole portion 88 which is widened rearward. The end portion 58 received in the hole portion 88 cannot be substantially moved relative to the mating contact 86.

The electric-shock protection pin 50 of the present embodiment has the aforementioned structure and is arranged as described above. However, the present invention is not limited thereto. The structure and the arrangement of the electric-shock protection pin 50 can be modified as necessary.

Hereafter, further specific explanation will be made about the structure of the electric-shock protection pin 50 of the present embodiment.

Referring to FIG. 6, under the initial state where the support portion 53 is not resiliently deformed, the end portion 58 of the electric-shock protection pin 50 is located at a predetermined position (see the electric-shock protection pin 50 illustrated with solid line in FIG. 6) and is apart from the contact 40 in the perpendicular plane (YZ-plane). The end portion 58 is moved from the predetermined position in the perpendicular plane in accordance with resilient deformation of the support portion 53 (see the electric-shock protection pin 50 illustrated with dashed line in FIG. 6). The end portion 58 moved from the predetermined position returns to the predetermined position in accordance with a return of the support portion 53 to the initial state. Thus, according to the electric-shock protection pin 50 of the present embodiment, when the end portion 58 is moved in a direction perpendicular to the front-rear direction, the support portion 53 is not plastically deformed but makes the end portion 58 return to the predetermined position by using a restoring force caused by its resilient deformation.

Referring to FIG. 7 together with FIG. 2, the connector 10 is moved so as to be inclined with the front-rear direction when the connector 10 receives a force along a direction intersecting with the mating direction (front-rear direction) under a state where the electric-shock protection pin 50 is received in the hole portion 88 of the mating contact 86. For example, the connector 10 under the mated state may be detached from the mating connector 80 while being vertically inclined about the mating portion 12. The existing electric-shock protection pin might be plastically deformed into a bent shape during this operation.

In contrast, according to the present embodiment, the electric-shock protection pin 50 is not plastically deformed but is resiliently deformed, for example, even when the connector 10 is inclined by a force applied to the connector 10 along a direction intersecting with the front-rear direction (mating direction) under the mated state. Thus, the present embodiment provides the connector 10 comprising the electric-shock protection pin 50 which is hardly deformed plastically even when the connector 10 receives a force along a direction intersecting with the mating direction.

Referring to FIG. 6, the electric-shock protection pin 50 of the present embodiment is resiliently deformable sufficiently. More specifically, according to the electric-shock protection pin 50 of the present embodiment, when a force which has moved the support portion 53 to bring it contact with the wall portion 22 is removed, the support portion 53 makes the end portion 58 return to the predetermined position. However, the present invention is not limited thereto. The electric-shock protection pin 50 should be resiliently deformable so that the electric-shock protection pin 50 can follow an assumed inclination of the connector 10.

As shown in FIG. 11, according to the electric-shock protection pin 50 of the present embodiment, a rear part of the front portion 56 of the support portion 53 extends rearward to the rear portion 55 while being tapered. Referring to FIG. 7, according to this structure, the support portion 53 and the end portion 58 will not be caught by a wall surface of the hole portion 88 even when the connector 10 is inclined during an operation in which the connector 10 is detached from the mating connector 80. Accordingly, the support portion 53 and the end portion 58 can be smoothly removed from the hole portion 88 with no problem. However, the present invention is not limited thereto. For example, the end portion 58 and the support portion 53 may have sizes in the perpendicular plane (YZ-plane) same as each other.

The present embodiment can be further variously modified in addition to the already described various modifications.

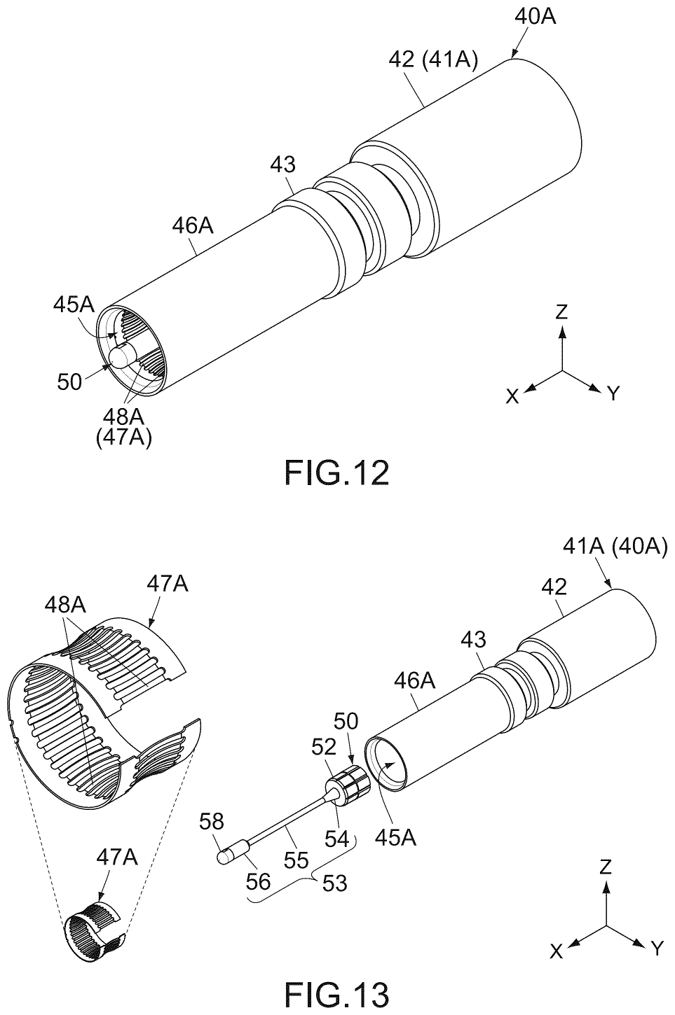

For example, referring to FIG. 12 together with FIG. 5, the connector 10 may comprise a contact 40A instead of the contact 40. The contact 40A holds the electric-shock protection pin 50 similarly to the contact 40. The contact 40A comprises a main member 41A and an additional member 47A which are formed separately from each other.

Comparing FIG. 12 with FIG. 8, the main member 41A comprises the cable connection portion 42 and the holding portion 43 same as those of the contact 40. Moreover, the main member 41A has a cylindrical portion 46A instead of the coupling portion 44 and the spring pieces 46 of the contact 40. The main member 41A has a structure similar to that of the contact 40 except for the aforementioned differences. For example, the cylindrical portion 46A is formed with a receiving portion 45A located therein.

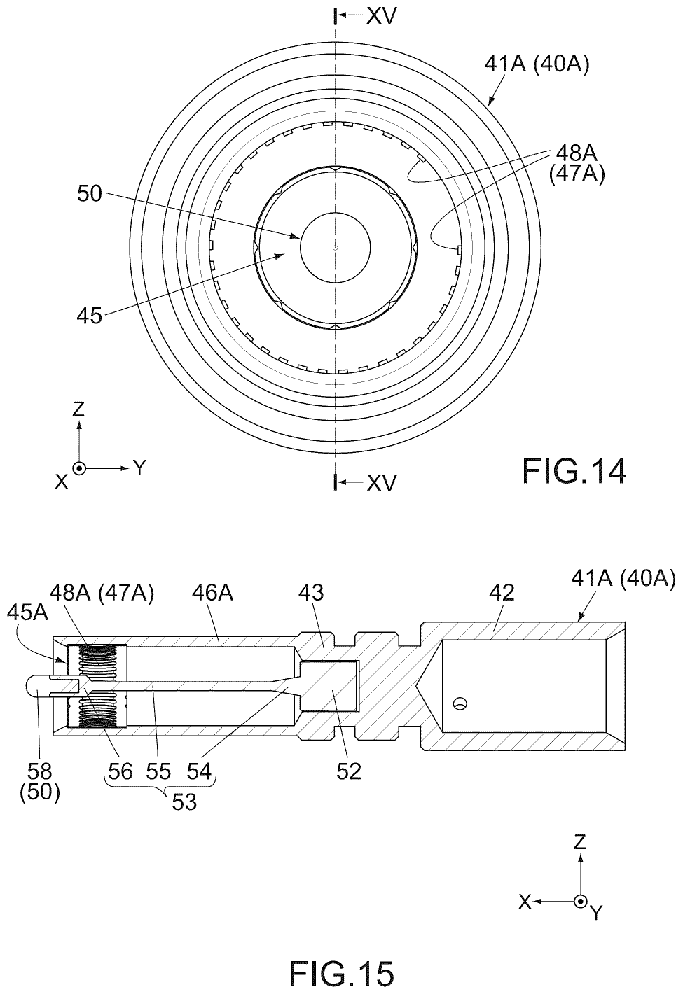

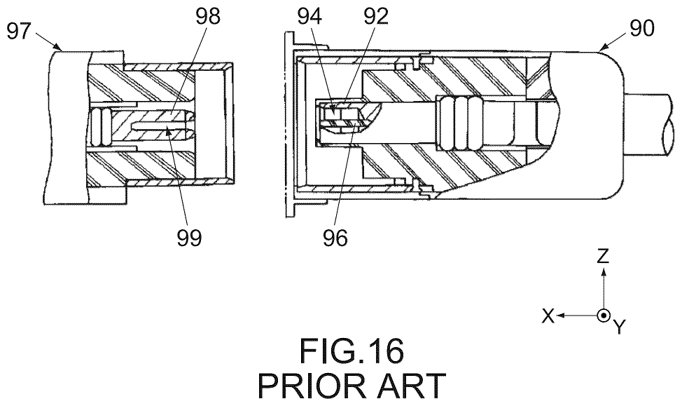

Referring to FIGS. 12 to 15, the additional member 47A is formed of a thin single metal plate and has a cylindrical shape with slits formed therein. The additional member 47A is formed with a plurality of contact portions 48A. Thus, the contact 40A has a plurality of the contact portions 48A. The contact portions 48A are arranged in a circle. Each of the contact portions 48A extends along the front-rear direction and protrudes inward in the perpendicular plane (YZ-plane). The additional member 47A is fixed on an inner surface of the receiving portion 45A of the contact 40A and extends along an inner wall surface of the cylindrical portion 46A in the perpendicular plane. Each of the contact portions 48A is arranged on an imaginary circular ring in the perpendicular plane and protrudes toward the center of the receiving portion 45A. In other words, the contact portions 48A are arranged in a louver arrangement.

Referring to FIG. 15 together with FIG. 7, the present modification also provides the connector 10 comprising the electric-shock protection pin 50 which is hardly deformed plastically even when the connector 10 receives a force along a direction intersecting with the mating direction.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector mateable with a mating connector, which is located forward of the connector, along a front-rear direction, the mating connector comprising a mating contact, wherein:
the connector comprises a housing, a contact and an electric-shock protection pin;
the housing is formed with an accommodation portion;
the accommodation portion opens forward;
the contact is accommodated in the accommodation portion and is held by the housing;
the contact is formed with a receiving portion;
the receiving portion is configured to receive the mating contact along the front-rear direction when the connector is mated with the mating connector;
the electric-shock protection pin has a support portion and an end portion;
the support portion is resiliently deformable and is located in the receiving portion;
the end portion is located at a front end of the electric-shock protection pin and is supported by the support portion;
the end portion has an insulation surface;
under an initial state where the support portion is not resiliently deformed, the end portion is located at a predetermined position and is apart from the contact in a perpendicular plane perpendicular to the front-rear direction;
the end portion is moved from the predetermined position in the perpendicular plane in accordance with resilient deformation of the support portion; and
the end portion moved from the predetermined position returns to the predetermined position in accordance with a return of the support portion to the initial state.

2. The connector as recited in claim 1, wherein:
the housing has a wall portion;
the wall portion is located around the accommodation portion in the perpendicular plane; and
when a force which has moved the support portion to bring it contact with the wall portion is removed, the support portion makes the end portion return to the predetermined position.

3. The connector as recited in claim 1, wherein the support portion of the electric-shock protection pin has a rod-like shape which extends along the front-rear direction.

4. The connector as recited in claim 1, wherein:
the contact has a plurality of spring pieces and a coupling portion;
the coupling portion couples the spring pieces together; and
each of the spring pieces is a cantilever which extends from the coupling portion.

5. The connector as recited in claim 1, wherein:
the contact has a plurality of contact portions; and
the contact portions are arranged in a louver arrangement.

6. The connector as recited in claim 1, wherein:
the support portion of the electric-shock protection pin has a front portion and a rear portion;
the front portion supports the end portion;
the rear portion extends rearward from the front portion; and
the rear portion is slimmer than the front portion and is resiliently deformable more easily than the front portion.

7. The connector as recited in claim 1, wherein the support portion of the electric-shock protection pin is made of metal.
